(19) United States
(12) Patent Application Publication
(10) Pub. No.: US 2007/0178367 A1
(43) Pub. Date: Aug. 2, 2007

(54) Direct oxidation fuel cell and method for operating direct oxidation fuel cell system

(75) Inventors: Hideyuki Ueda, Osaka (JP); Shinsuke Fukuda, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/698,902

(22) Filed: Jan. 29, 2007

(30) Foreign Application Priority Data
Feb. 1, 2006 (JP) 2006-024366

(51) Int. Cl. H01M 4/94; H01M 8/10; H01M 8/02; H01M 8/04

(52) U.S. Cl. 429/44; 429/30; 429/38; 429/42; 429/13; 429/24

(57) ABSTRACT

A direct oxidation fuel cell includes at least one unit cell. The at least one unit cell includes an anode, a cathode, and a hydrogen-ion conductive polymer electrolyte membrane interposed between the anode and the cathode. The anode includes: a catalyst layer in contact with the polymer electrolyte membrane; and a diffusion layer. The diffusion layer includes: a porous composite layer containing a water-repellent binding material and an electron-conductive material; a first conductive porous substrate provided on the anode-side separator side of the porous composite layer; and a second conductive porous substrate provided on the catalyst layer side of the porous composite layer.

### FIELD OF THE INVENTION

The present invention relates to fuel cells, and, more particularly, to a solid polymer electrolyte fuel cell that directly uses fuel without reforming it into hydrogen and to a method for operating a system including such a solid polymer electrolyte fuel cell.

### BACKGROUND OF THE INVENTION

Portable small-sized electronic appliances, such as cellular phones, personal digital assistants (PDAs), notebook PCs, and video cameras, have been becoming more and more sophisticated, and the electric power consumed by these appliances and the continuous operating time thereof have been increasing commensurately. To cope with this, there is a strong demand that the batteries used to power such small-sized electronic appliances have higher energy density. Currently, lithium secondary batteries are mainly used as the power source for these appliances, but it is predicted that the energy density of lithium secondary batteries will soon reach its limit at about 600 Wh/L. As an alternative power source to lithium secondary batteries, it is desired to bring fuel cells using a solid polymer electrolyte membrane into practical use as early as possible.

Among solid polymer electrolyte fuel cells, direct oxidation fuel cells are receiving attention. Direct oxidation fuel cells generate power by directly supplying fuel into a cell without reforming it into hydrogen, and oxidizing the fuel on an electrode. They utilize organic fuel, which has high theoretical energy density and is easy to store, so their system can be simplified. Thus, active research and development is underway.

For example, a direct methanol fuel cell has at least one unit cell that includes a membrane electrode assembly (MEA) sandwiched between anode-side and cathode-side separators. The MEA is composed of a solid polymer electrolyte membrane sandwiched between an anode and a cathode. Each of the anode and the cathode comprises a catalyst layer and a diffusion layer. This fuel cell generates power by supplying methanol or a methanol aqueous solution as fuel to the anode side and supplying an oxidant gas, typically, air, to the cathode side.

The electrode reactions of the direct methanol fuel cell are as follows.

Anode: CH₃OH+H₂O→CO₂+6H⁺+6e⁻

Cathode: 3/2O₂+6H⁺+6e⁻→3H₂O

On the anode, methanol reacts with water to produce carbon dioxide, protons, and electrons. The protons migrate to the cathode through the electrolyte membrane. On the cathode, the protons and oxygen combine with electrons that have passed through an external circuit to produce water.

However, commercialization of such direct methanol fuel cells has some problems.

One of the problems is “methanol crossover”, which is a phenomenon in which methanol supplied to the anode side migrates to the cathode side through the electrolyte membrane without reacting. An ion exchange membrane made of perfluoroalkyl sulfonic acid is used as the electrolyte membrane of direct methanol fuel cells in view of its proton conductivity, heat resistance, and acid resistance. This type of electrolyte membrane is composed of a main chain of hydrophobic polytetrafluoroethylene (PTFE) and side chains of perfluoro groups having hydrophilic sulfonic acid groups at the terminals. Since methanol has both hydrophilic and hydrophobic moieties, it serves as a good solvent for the electrolyte membrane and easily passes through the electrolyte membrane.

Methanol crossover lowers not only fuel utilization rate but also cathode potential, thereby causing a significant degradation of power generating characteristics. The occurrence of methanol crossover tends to increase as the methanol concentration becomes higher. Hence, the currently used methanol solution is diluted so that it has a methanol concentration of approximately 2 to 4 M. The use of such low concentration fuel is a large obstacle to the size reduction of fuel cell systems.

Another problem relates to concentration polarization on the anode side. In direct methanol fuel cells, which use a methanol aqueous solution (liquid fuel) as fuel, the fuel diffusion speed on the anode side is slower than that in fuel cells utilizing hydrogen. The slow fuel diffusion can cause degradation of power generating characteristics. Particularly, downstream of the fuel flow channel, methanol fuel is consumed, so the fuel supply to the catalyst layer becomes significantly insufficient, thereby causing an increase in methanol concentration polarization. On the other hand, if the methanol concentration is increased in order to avoid this problem, excessive methanol is supplied to the catalyst layer upstream of the fuel flow channel. Consequently, methanol crossover increases, thereby resulting in a decrease in power generating characteristics and fuel utilization rate.

Therefore, to solve these problems, many proposals have been made to improve the structure of the anode diffusion layer itself.

For example, in order to suppress methanol crossover in the first half of the fuel flow channel and insufficient supply of methanol in the latter half of the fuel flow channel for evenly supplying fuel to the anode catalyst layer, Patent Document 1 (Japanese Laid-Open Patent Publication No. 2002-110191) discloses a direct methanol fuel cell in which the methanol permeation coefficient of the anode diffusion layer is made greater more downstream of the fuel flow channel. The anode diffusion layer comprises a substrate such as carbon paper and a mixed layer of carbon black and polytetrafluoroethylene formed on the surface of the substrate. Patent Document 1 describes such methods as reducing the thickness of the mixed layer, the weight ratio of the polytetrafluoroethylene, or the water-repellency of the carbon black, or increasing the porosity and pore size of the carbon black, along the flow direction of fuel.

In order to evenly supply fuel to the anode catalyst layer and improve the dischargeability of carbon dioxide (reaction product), Patent Document 2 (Japanese Laid-Open Patent Publication No. 2005-108837) discloses an electrode diffusion layer having liquid fuel supply paths (hydrophilic paths, which connect the catalyst layer to the substrate of the diffusion layer) and gaseous product discharge paths (hydrophobic paths) that are independent of each other in a random manner. The hydrophilic paths are composed of a porous aggregate of electronically conductive particles, which forms a three-dimensional network serving as transmission paths of polar liquid. The hydrophobic paths are composed of a porous aggregate of electrically conductive particles and a hydrophobic binder resin, which forms a three-dimensional network that does not get wet with polar liquid and serves as transmission paths of gas.

Further, in order to reduce the concentration polarization of liquid fuel in the anode, Patent Document 3 (Japanese Laid-Open Patent Publication No. 2004-342489) discloses an anode diffusion layer composed of a conductive porous substrate coated with a hydrophilic material and a conductive powder filled in the substrate.

In reducing the size and weight of fuel cells and enabling long-time operation, utilizing high concentration fuel is an effective means. However, according to these conventional approaches, it is difficult to provide a direct oxidation fuel cell having excellent power generating characteristics without lowering fuel utilization rate under operating conditions employing high concentration fuel, and there still remain a number of problems to be solved.

In the case of the technique represented by Patent Document 1, careful consideration is not given to the effects of methanol concentration and operating temperature for power generation on the methanol permeation coefficient of the anode diffusion layer. Hence, for example, when high concentration methanol is used or the operating temperature for power generation is raised, methanol crossover increases and power generating characteristics significantly degrade.

In the case of the techniques represented by Patent Document 2 or 3, the dischargeability of the reaction product carbon dioxide is improved. However, the diffusion layer itself is not designed such that the diffusion of methanol in the direction perpendicular to the fuel flow channel (thickness direction of the diffusion layer) is suitably blocked and the diffusion of methanol in the direction parallel to the fuel flow channel (plane direction of diffusion layer) is ensured. Therefore, for example, in the case of supplying a small amount of high concentration methanol which is close to the amount consumed by power generation, the supply of the methanol fuel to the catalyst layer becomes uneven, thereby causing degradation of power generating characteristics.

### BRIEF SUMMARY OF THE INVENTION

In view of the above-mentioned problems, it is an object of the present invention to provide a direct oxidation fuel cell which, even in the case of directly supplying high concentration fuel, has excellent power generating characteristics without lowering fuel utilization efficiency, by realizing even supply of the fuel to the whole area of a catalyst layer and a reduction in fuel crossover at the same time.

The anode diffusion layer basically has the functions of: evenly supplying/diffusing fuel from the fuel flow channel to the catalyst layer; promptly discharging carbon dioxide produced in the catalyst layer into the fuel flow channel; and promptly transmitting electrons produced in the catalyst layer to the separator. In addition to these basic functions, the anode diffusion layer of the present invention is provided with a new function of controlling fuel permeation flux. This new function is intended to enable even supply of a suitable amount of fuel to the anode catalyst layer and a reduction in fuel crossover and concentration polarization due to insufficient fuel supply.

The present invention relates to a direct oxidation fuel cell including at least one unit cell. The at least one unit cell includes an anode, a cathode, a hydrogen-ion conductive polymer electrolyte membrane interposed between the anode and the cathode, an anode-side separator with a flow channel for supplying and discharging a fuel to and from the anode, and a cathode-side separator with a gas flow channel for supplying and discharging an oxidant gas to and from the cathode.

The present invention is characterized in that the anode includes: a catalyst layer in contact with the polymer electrolyte membrane; and a diffusion layer, and that the diffusion layer includes: a porous composite layer comprising a water-repellent binding material and an electron-conductive material; a first conductive porous substrate provided on the anode-side separator side of the porous composite layer; and a second conductive porous substrate provided on the catalyst layer side of the porous composite layer.

The present invention also provides a method for operating a fuel cell system including the above-mentioned fuel cell. The fuel cell system includes a fuel tank connected to an inlet of the anode of the fuel cell by a fuel supply path; a fuel discharge path connected to an outlet of the anode of the fuel cell; an oxidant supply source connected to an inlet of the cathode of the fuel cell by an oxidant supply path; and an oxidant discharge path connected to an outlet of the cathode of the fuel cell. The operation method is characterized in that the amount of the fuel supplied to the anode of the fuel cell is 1.1 to 2.2 times the amount of the fuel consumed by power generation of the fuel cell.

According to the present invention, when high concentration fuel is supplied to the anode, the fuel blockability of the diffusion layer in the thickness direction thereof can be controlled while the fuel diffusibility of the diffusion layer in the plane direction thereof can be enhanced. As a result, it is possible to evenly supply the fuel to the whole area of the catalyst layer and reduce fuel crossover at the same time.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1A is a schematic view of an anode diffusion layer according to the present invention in which the diffusion of fuel is illustrated;

FIG. 1B is a schematic view of an anode diffusion layer in a comparative example in which the diffusion of fuel is illustrated;

FIG. 2 is a schematic longitudinal sectional view of a unit cell of a fuel cell in one embodiment of the present invention;

FIG. 3 is a schematic sectional view showing the structure of the main part of the anode diffusion layer of the unit cell;

FIG. 4 is a block diagram showing the structure of a fuel cell system in one embodiment of the present invention; and

FIG. 5 is a schematic longitudinal sectional view showing the structure of a device for measuring methanol permeation flux.

### DETAILED DESCRIPTION OF THE INVENTION

The direct oxidation fuel cell of the present invention includes at least one unit cell. The at least one unit cell includes an anode, a cathode, a hydrogen-ion conductive polymer electrolyte membrane interposed between the anode and the cathode, an anode-side separator with a flow channel for supplying and discharging a fuel to and from the anode, and a cathode-side separator with a gas flow channel for supplying and discharging an oxidant gas to and from the cathode.

The anode includes: a catalyst layer in contact with the polymer electrolyte membrane; and a diffusion layer, and the diffusion layer includes: a porous composite layer comprising a water-repellent binding material and an electron-conductive material; a first conductive porous substrate provided on the anode-side separator side of the porous composite layer; and a second conductive porous substrate provided on the catalyst layer side of the porous composite layer.

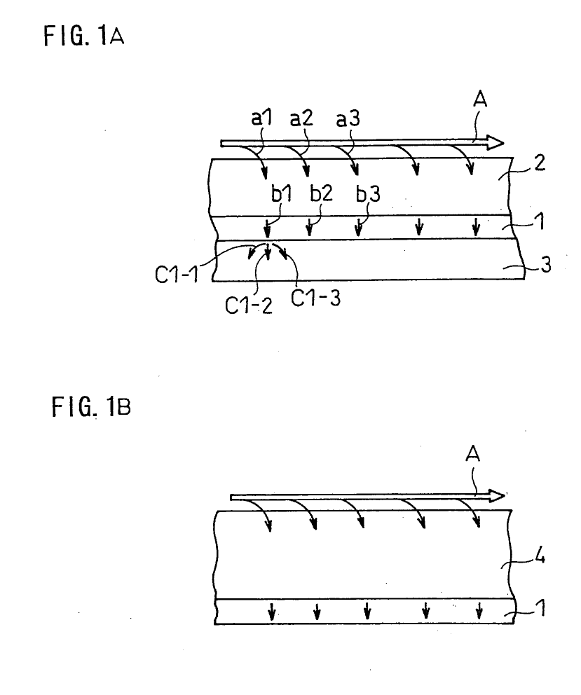

FIG. 1A schematically illustrates the structure of the anode diffusion layer.

This diffusion layer comprises a laminate of at least three layers: a porous composite layer 1 containing a water-repellent binding material and an electron-conductive material; a first conductive porous substrate 2 disposed on the anode-side separator side of the porous composite layer 1; and a second conductive porous substrate 3 disposed on the catalyst layer side of the porous composite layer 1.

When a fuel, for example, a methanol aqueous solution is supplied to this diffusion layer in the direction shown by an arrow A, the fuel diffuses into the first conductive porous substrate 2 as shown by arrows a1, a2, and a3. In the porous substrate 2, the fuel diffuses not only in the thickness direction thereof but also in the plane direction, but the fuel concentration in the porous substrate usually becomes higher upstream of the fuel supply than downstream. The fuel that has diffused through the porous substrate 2 then diffuses into the porous composite layer 1 in the thickness direction of, as shown by arrows b1, b2, and b3, and reaches the second conductive porous substrate 3. In the porous substrate 3, since the fuel also diffuses in the plane direction of the porous substrate 3, the fuel that has diffused as shown by the arrow b1 diffuses as shown by arrows cl-1, cl-2, and cl-3. Likewise, the fuel that has diffused as shown by the arrows b2 and b3 diffuses in the plane direction of the porous substrate. In this way, the fuel diffuses toward the backside of the substrate and reaches the catalyst layer.

FIG. 1B shows the structure of a diffusion layer in a comparative example. This diffusion layer is composed of two layers: a porous composite layer 1, which is the same as that of FIG. 1A; and a porous substrate 4 disposed on the anode-side separator side of the porous composite layer 1.

When a fuel is supplied to the diffusion layer in the direction shown by an arrow A, it diffuses into the porous substrate 4, reaches the porous composite layer 1, and diffuses in the thickness direction of the porous composite layer 1.

In the structure of FIG. 1B, if the flux of fuel permeating through the porous substrate 4 is increased, the fuel is unable to sufficiently diffuse in the plane direction of the diffusion layer. Thus, the fuel concentration of the catalyst layer becomes uneven, thereby resulting in poor power generating characteristics. Also, if the flux of fuel permeating through the porous substrate 4 is reduced, the fuel supply to the catalyst layer becomes insufficient, thereby increasing concentration polarization and impairing power generating characteristics.

Contrary to this, in the structure of FIG. 1A, in the porous composite layer 1 interposed between the porous substrates 2 and 3, the diffusion of fuel in the thickness direction of the diffusion layer is suitably blocked and, in the porous substrates 2 and 3, the diffusion of fuel in the plane direction of the diffusion layer is promoted. It is therefore possible to suppress fuel crossover, supply fuel to the catalyst layer almost evenly, and improve power generating characteristics.

The flux of fuel permeating through the first conductive porous substrate and the porous composite layer is preferably less than the flux of fuel permeating through the second conductive porous substrate.

In this case, when high concentration fuel is supplied, the diffusibility of the fuel penetrating the whole area of the diffusion layer can be controlled evenly. It is thus possible to solve the problem of fuel crossover upstream of the fuel flow channel due to excessive fuel supply and the problem of concentration polarization downstream thereof due to insufficient fuel supply at the same time.

In the anode diffusion layer of the present invention, the porous composite layer has a substantially flat surface to which the second conductive porous substrate is joined, so that the water-repellent binding material and the electron-conductive material of the porous composite layer are kept from getting into the second conductive porous substrate. If the water-repellent binding material and electron-conductive material of the porous composite layer get into the second conductive porous substrate, the diffusibility of fuel in the plane direction of the diffusion layer decreases. In order to keep the constituent materials of the porous composite layer from getting into the second conductive porous substrate, it is desirable to employ the following fabrication method. First, a porous composite layer is formed on a first conductive porous substrate such that the face of the porous composite layer to which a second conductive porous substrate is to be joined has a substantially flat surface. Then, the second conductive porous substrate is joined to the flat surface of the porous composite layer.

As used herein, the expression “the water-repellent binding material and the electron-conductive material of the porous composite layer are kept from getting into the second conductive porous substrate” means that the water-repellent binding material and the electron-conductive material are kept from getting into the second conductive porous substrate to such an extent that diffusion of fuel in the plane direction of the second conductive porous substrate is not affected.

In the anode diffusion layer of the present invention, the water-repellent binding material in the porous composite layer is preferably composed mainly of fluorocarbon resin.

The use of fluorocarbon resin having chemically stable C—F bonding as the water-repellent binding material permits formation of a “water-repellent” surface, i.e., a surface having small interaction with other molecules. Examples of fluorocarbon resin include polytetrafluoroethylene resin (PTFE), tetrafluoroethylene-hexafluoropropylene copolymer (FEP), polyvinyl fluoride resin (PVF), polyvinylidene fluoride resin (PVDF), and tetrafluoroethylene-perfluoro (alkyl vinyl ether) copolymer (PFA).

In the anode diffusion layer of the present invention, the electron-conductive material in the porous composite layer is preferably composed mainly of conductive carbon black.

Conductive carbon black is a highly structured material (primary particles that are agglomerated in a permanent manner) with a large specific surface area. Thus, the use of such conductive carbon black as the electron-conductive material permits prompt discharge of carbon dioxide produced in the catalyst layer through the pores of the structure while ensuring electronic conductivity.

In the anode diffusion layer of the present invention, a water-repellent binding material may be attached to the first and second conductive porous substrates. In this case, by adjusting the amount of the water-repellent binding material attached thereto, the fuel permeation flux can be controlled.

When the water-repellent binding material accumulates on the surfaces of the first and second conductive porous substrates or the inner walls of pores of these porous substrates, it forms a large number of asperities (fractals) derived from the particle shape of the water-repellent binding material thereon. Hence, the water-repellency of the substrates themselves can be enhanced. Thus, by adjusting the amount of the water-repellent binding material attached to the first and second conductive porous substrates, the water-repellency of the substrates can be changed and the fuel permeation flux can be controlled.

In the anode diffusion layer of the present invention, the water-repellent binding material attached to the first and second conductive porous substrates is preferably composed mainly of fluorocarbon resin. This fluorocarbon resin may be selected from the same fluorocarbon resins listed as the water-repellent binding materials for use in the porous composite layer.

The fuel cell system of the present invention is preferably operated such that the amount of fuel supplied to the fuel cell is 1.1 to 2.2 times the amount of fuel consumed by power generation.

When the amount of fuel supplied to the fuel cell is very close to the amount of fuel consumed by power generation, the amount of fuel crossover due to surplus fuel can be reduced significantly. If the amount of fuel supply is more than 2.2 times the amount of fuel consumed by power generation, a significant degradation of power generating characteristics occurs due to fuel crossover.

The amount of fuel consumed by the fuel cell is determined from a desired output. Also, the amount of fuel supply can be controlled by adjusting the concentration of fuel supplied to the fuel cell and the supply speed thereof.

In a preferable embodiment of the method for operating the fuel cell system of the present invention, the fuel is methanol or a methanol aqueous solution, and power is generated at a fuel concentration and a cell temperature such that the flux of fuel permeating through two layers of the first conductive porous substrate and the porous composite layer is 0.6×10⁻⁴ to 1.5×10⁻⁴ mol/(cm²·min).

By setting the flux of methanol permeating through the two layers of the first conductive porous substrate on the fuel flow channel side and the porous composite layer in the above-mentioned range, it becomes possible to optimize the blockability of fuel in the thickness direction of the diffusion layer and solve the problem of fuel crossover upstream of the fuel flow channel due to excessive fuel supply. If the methanol permeation flux exceeds 1.5×10⁻⁴ mol/(cm²·min), the methanol permeation speed in the thickness direction of the diffusion layer significantly increases, so that the supply of methanol to the whole area of the catalyst layer becomes uneven, thereby resulting in degradation of power generating characteristics. On the other hand, if the methanol permeation flux is less than 0.6×10⁻⁴ mol/(cm²·min), the supply of fuel to the catalyst layer becomes insufficient, so that the concentration polarization increases, thereby impairing power generating characteristics.

In another preferable embodiment of the method for operating the fuel cell system of the present invention, the fuel is methanol or a methanol aqueous solution, and power is generated at a fuel concentration and a cell temperature such that the flux of fuel permeating through the second conductive porous substrate is 4.5×10⁴ to 8.0×10⁻⁴ mol/(cm²·min).

By setting the flux of methanol permeating through the second conductive porous substrate in the above-mentioned range, it becomes possible to evenly diffuse a suitable amount of methanol in the plane direction of the diffusion layer and solve the problem of concentration polarization downstream of the fuel flow channel due to insufficient fuel supply. If the methanol permeation flux exceeds 8.0×10⁻⁴ mol/(cm²·min), the methanol permeation speed in the thickness direction of the second conductive porous substrate significantly increases relative to the methanol permeation speed in the plane direction thereof, so that the supply of methanol to the whole area of the catalyst layer becomes uneven, thereby resulting in degradation of power generating characteristics. On the other hand, if the methanol permeation flux is less than 4.5×10⁻⁴ mol/(cm²·min), the supply of fuel to the catalyst layer becomes insufficient, so that the concentration polarization increases, thereby impairing power generating characteristics.

As described above, according to the present invention, even when high concentration fuel is directly supplied, the fuel can be evenly supplied to the whole area of the catalyst layer while the fuel crossover can be reduced. It is therefore possible to provide a direct oxidation fuel cell having excellent power generating characteristics without lowering fuel utilization rate.

Referring now to drawings, embodiments of the present invention are described.

### Embodiment 1

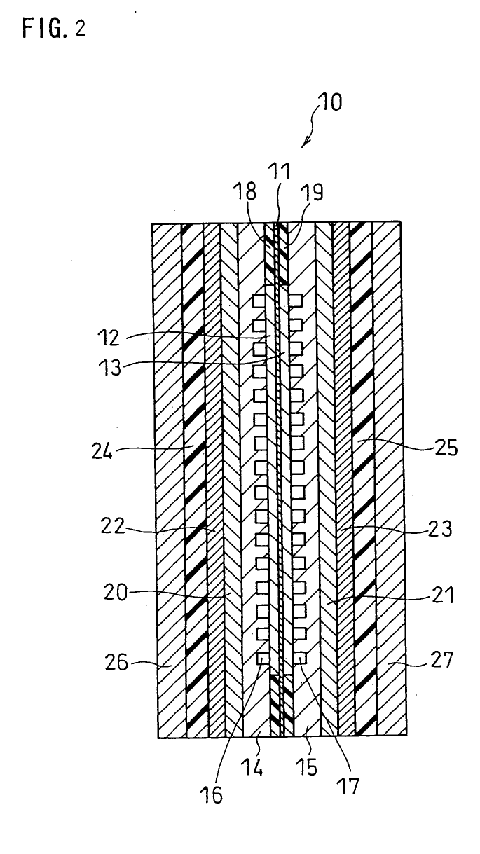

FIG. 2 is a schematic longitudinal sectional view showing the structure of a fuel cell in one embodiment of the present invention. In this example, the fuel cell is composed of one unit cell. A unit cell 10 includes a membrane electrode assembly (MEA) sandwiched between an anode-side separator 14 and a cathode-side separator 15. The MEA includes a hydrogen-ion conductive electrolyte membrane 11 and an anode 12 and a cathode 13 sandwiching the electrolyte membrane 11. Each of the anode and the cathode comprises a catalyst layer in contact with the electrolyte membrane and a diffusion layer on the separator side. The anode-side separator 14 has a flow channel 16, through which a fuel is supplied and discharged, on the anode-facing side thereof. The cathode-side separator 15 has a gas flow channel 17, through which an oxidant gas is supplied and discharged, on the cathode-facing side thereof. Gaskets 18 and 19 are fitted around the anode and the cathode so as to sandwich the electrolyte membrane.

The unit cell 10 further includes current collector plates 20 and 21, heater plates 22 and 23, insulator plates 24 and 25, and end plates 26 and 27 on both sides thereof, and these components are integrally secured with clamping means.

The electrolyte membrane 11 may be made of any hydrogen-ion (proton) conductive material with good heat resistance and chemical stability, and the material is not particularly limited.

Each of the anode and cathode catalyst layers is a thin film of approximately 10 to 100 μm in thickness, which is composed mainly of a polymer electrolyte and conductive carbon particles with a catalyst metal carried thereon or catalyst metal fine particles. The catalyst metal of the anode catalyst layer is a platinum-ruthenium (Pt—Ru) alloy in the form of fine particles, while the catalyst metal of the cathode catalyst layer is Pt in the form of fine particles. As the polymer electrolyte, it is preferred to use the same material as that of the electrolyte membrane 11.

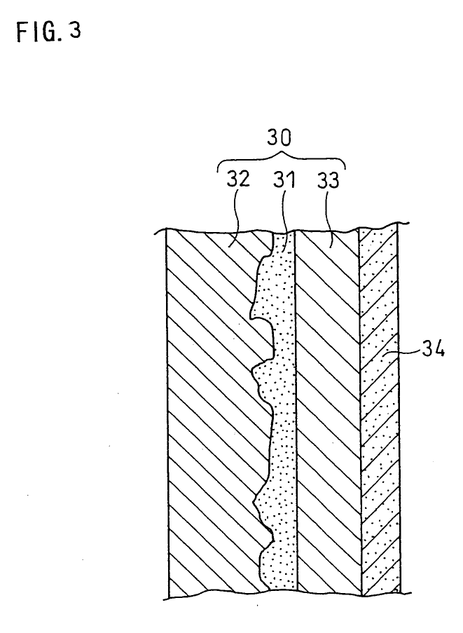

As illustrated in FIG. 3, the anode 12 includes a diffusion layer 30 and a catalyst layer 34. The diffusion layer 30 is a laminate of at least three layers: a porous composite layer 31 comprising a water-repellent binding material and an electron-conductive material; a first conductive porous substrate 32 disposed on the anode-side separator side of the porous composite layer 31; and a second conductive porous substrate 33 disposed on the catalyst layer side of the porous composite layer 31.

The water-repellent binding material of the porous composite layer 30 may be any material composed mainly of fluorocarbon resin. Preferable examples of fluorocarbon resin include polytetrafluoroethylene resin (PTFE), tetrafluoroethylene-hexafluoropropylene copolymer (FEP), polyvinyl fluoride resin (PVF), polyvinylidene fluoride resin (PVDF), and tetrafluoroethylene-perfluoro (alkyl vinyl ether) copolymer (PFA). The electron-conductive material of the porous composite layer 30 may be any material composed mainly of conductive carbon black. A preferable example of conductive carbon black is a highly structured material with a specific surface area of 200 m²/g or more. The first and second conductive porous substrates may comprise a conductive porous material with fuel diffusibility, dischargeability of carbon dioxide produced by power generation, and electronic conductivity to which a water-repellent binding material composed mainly of fluorocarbon resin is attached. Examples of such conductive porous materials include carbon paper and carbon cloth, and examples of such water-repellent binding materials include polytetrafluoroethylene resin, tetrafluoroethylene-hexafluoropropylene copolymer, polyvinyl fluoride resin, polyvinylidene fluoride resin, and tetrafluoroethylene-perfluoro (alkyl vinyl ether) copolymer.

The materials of the porous composite layer 10 are kept from getting into the second conductive porous substrate on the catalyst layer side.

The diffusion layer of the cathode 13 may be a conductive porous substrate with air diffusibility, dischargeability of water produced by power generation, and electronic conductivity, such as carbon paper or carbon cloth.

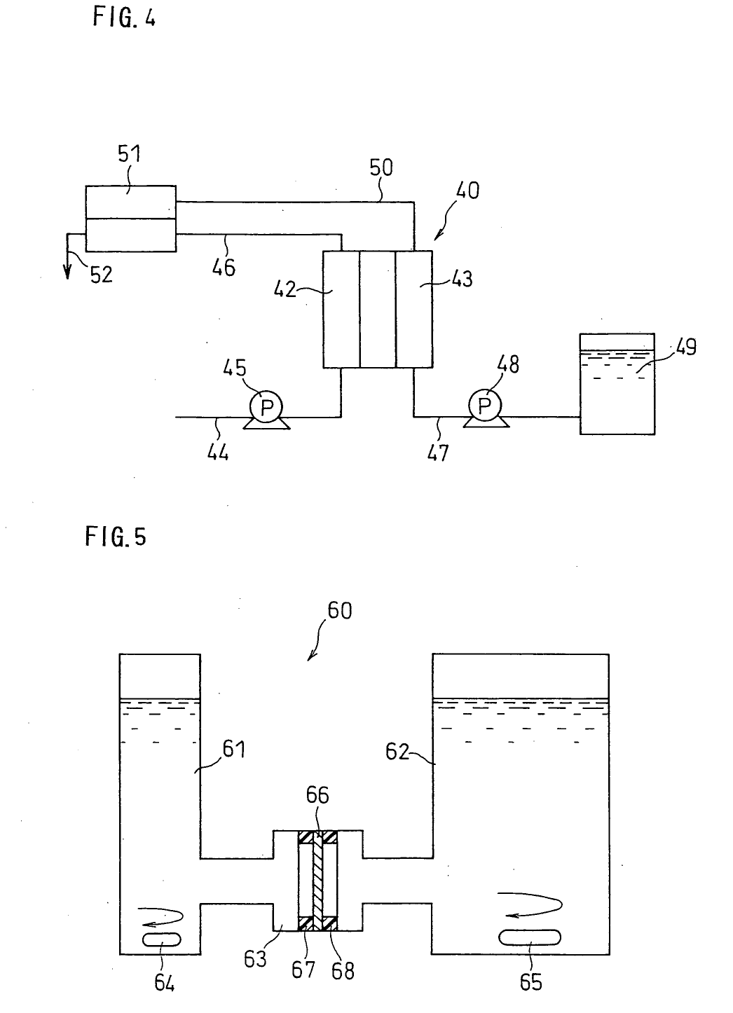

FIG. 4 shows one embodiment of a system including the above-described fuel cell of the present invention. This system is a non-circulation type fuel cell system in which liquid and gas discharged from the anode side of the fuel cell are not recovered for reuse in power generation. That is, the amount of fuel supply is made as close to the amount consumed by power generation as possible, so that the amount of fuel discharged from the anode side is minimized. Thus, there is no need to use such devices as a cooler and a gas-liquid separator.

A fuel cell 40 includes a stack of one or more unit cells, which is sandwiched between current collector plates, heater plates, insulator plates, and end plates. The heater plates are used for controlling the cell temperature. A fuel in a fuel tank 49 is supplied to an anode 43 of the fuel cell 40 through a fuel supply path 47 equipped with a fuel pump 48. Air, serving as an oxidant gas, is supplied to a cathode 42 of the fuel cell 40 through an air supply path 44 equipped with an air pump 45. The fuel discharged from the anode 43 of the fuel cell 40 is transported to a catalyst combustor 51 through a fuel discharge path 50. The air discharged from the cathode 42 is transported to the catalyst combustor 51 through an air discharge path 46. The fuel discharged from the fuel cell is oxidized/purified in the catalyst combustor and released into the atmosphere as air containing water and carbon dioxide. The catalyst combustor 51 is composed of two combustion chambers divided by a porous sheet with a catalyst layer. One of the combustion chambers has only an inlet into which the fuel discharged from the fuel cell 40 is introduced. The other combustion chamber has an inlet into which air is introduced and a discharge path 52 from which air containing water and carbon dioxide is discharged after catalytic combustion.

The fuel cell system is operated at a fuel concentration and a cell temperature such that the methanol permeation flux through the anode diffusion layer is in the preferable range of the present invention. Such fuel concentration and cell temperature are determined by the following steps.

### (1) First Step

Using a device for measuring methanol permeation flux as illustrated in FIG. 5, the methanol permeation flux through the diffusion layer is measured under conditions where the concentration and temperature of a methanol aqueous solution are varied. Specifically, the flux of methanol permeating through the porous composite layer integrated with the first conductive porous substrate and the flux of methanol permeating through the second conductive porous substrate are measured. This measurement method of methanol permeation flux using the device of FIG. 5 is described later in Examples.

The measurement temperature is set in the range of 20 to 80° C. in consideration of the actual operating temperatures. The device is left in a constant temperature oven at a predetermined temperature for 60 minutes, and the measurement is started after the temperature of the methanol aqueous solution is stabilized.

### (2) Second Step

Based on the measurement results, the methanol concentration and temperature that provide the preferable permeation flux are determined.

When the methanol concentration and temperature that provide the preferable permeation flux through the porous composite layer integrated with the first conductive porous substrate are different from those for the second conductive porous substrate, the methanol concentration and temperature preferable for the second conductive porous substrate are employed. Then the thickness and composition of the porous composite layer are adjusted such that the same methanol concentration and temperature provide the preferable permeation flux through the porous composite layer integrated with the first conductive porous substrate.

### (3) Third Step

The fuel cell system is operated to generate power by supplying a fuel with the methanol concentration determined by the second step to the anode and setting the cell temperature so as to achieve the temperature of the methanol aqueous solution determined by the second step.

The present invention is hereinafter described more specifically by way of Examples.

### EXAMPLE 1

Anode catalyst-carrying particles were prepared by placing 30% by weight of Pt and 30% by weight of Ru, each having a mean particle size of 3 nm, on carbon black (conductive carbon particles) with a mean primary particle size of 30 nm (ketjen black EC available from Mitsubishi Chemical Corporation). Also, cathode catalyst-carrying particles were prepared by placing 50% by weight of Pt with a mean particle size of 3 nm on the same ketjen black EC. Each of the anode and cathode catalyst-carrying particles was ultrasonically dispersed in an isopropanol aqueous solution. Each dispersion was mixed with a polymer electrolyte and then highly dispersed in a bead mill. In this way, an anode catalyst paste and a cathode catalyst paste were prepared. The weight ratio between the conductive carbon particles and the polymer electrolyte in each catalyst paste was 1:1. The polymer electrolyte used was a perfluorocarbon sulfonic acid ionomer (Flemion available from Asahi Glass Co., Ltd.).

Each of the anode and cathode catalyst pastes was applied onto a polytetrafluoroethylene sheet (Naflon PTFE sheet available from NICHIAS Corporation) with a doctor blade and dried in the air at room temperature for 6 hours. In this way, an anode catalyst layer and a cathode catalyst layer were formed. These sheets with the catalyst layers were cut to a size of 6 cm×6 cm. An electrolyte membrane was sandwiched between the sheet with the anode catalyst layer and the sheet with the cathode catalyst layer such that the respective catalyst layers were positioned inward. This combination was hot pressed at 130° C. at 7 MPa for 5 minutes so that the respective catalyst layers were bonded to the electrolyte membrane. The electrolyte membrane used was an ion exchange membrane of perfluoroalkyl sulfonic acid (Nafion 117 available from E.I. Du Pont de Nemours & Company). Thereafter, the polytetrafluoroethylene sheet was removed from the assembly thus obtained, so that the anode catalyst layer and the cathode catalyst layer were formed on the electrolyte membrane. The amount of Pt in each of the anode and the cathode was 1.8 mg/cm².

Carbon paper (TGP-H090 available from Toray Industries Inc.) serving as the first conductive porous substrate was immersed in a dispersion containing 7% by weight of polytetrafluoroethylene resin (PTFE) (D-1E, available from Daikin Industries, Ltd., diluted with ion-exchange water) for 1 minute. The carbon paper was then dried in the atmosphere at room temperature for 3 hours and baked at 360° C. in nitrogen gas for 1 hour to remove the surfactant. In this way, it was imparted with water-repellency. The amount of PTFE attached to the first conductive porous substrate was 11.5% by weight.

Next, the porous composite layer 31 was formed on the surface of the thus obtained first conductive porous substrate 32 in the following manner. First, conductive carbon black (Vulcan XC-72R available from CABOT Corporation) was ultrasonically dispersed in an aqueous solution containing a surfactant (Triton X-100 available from Sigma-Aldrich Corporation) and then highly dispersed by using HIVIS MIX (available from PRIMIX Corporation). This dispersion was mixed with a PTFE dispersion (D-1E available from Daikin Industries, Ltd.) and again highly dispersed to prepare a paste for forming the porous composite layer. This porous composite layer paste was evenly applied onto the whole surface of the first conductive porous substrate 32 with a doctor blade and dried in the atmosphere at room temperature for 8 hours. Thereafter, it was baked at 360° C. in nitrogen gas for 1 hour to remove the surfactant. The porous composite layer 31 thus obtained had a weight ratio of conductive carbon black/PTFE of ⅗ and a thickness of approximately 50 μm.

Next, the first conductive porous substrate 32 with the porous composite layer 31 formed thereon and the second conductive porous substrate 33 were cut to a size of 6 cm×6 cm. The second conductive porous substrate 33 was then placed on the porous composite layer 31 formed on the first conductive porous substrate 32 and hot pressed at 130° C. and 4 MPa for 3 minutes, to obtain the diffusion layer 30. The second conductive porous substrate 33 used was carbon paper (TGP-H060 available from Toray Industries Inc.), which was also subjected to a water-repellency treatment with a dispersion containing 3% by weight of PTFE in the same manner as the first conductive porous substrate 32 so that 5.5% by weight of PTFE was attached thereto.

By forming the diffusion layer 30 as described above, the porous composite layer 31 and the second conductive porous substrate 33 could be laminated without allowing the materials of the porous composite layer 31 to get into the second conductive porous substrate 33.

Next, the electrolyte membrane 11 with the anode catalyst layer and the cathode catalyst layer was sandwiched between the anode diffusion layer 30 of 6 cm×6 cm and the cathode diffusion layer of 6 cm×6 cm. This assembly was hot pressed at 130% and 4 MPa for 3 minutes. The cathode diffusion layer used was carbon cloth (LT2500W available from E-TEK).

Further, the gaskets 18 and 19 were thermally bonded at 130° C. and 4 MPa around the anode 12 and the cathode 13 for 5 minutes so as to sandwich the electrolyte membrane 11, which gave an MEA.

The MEA was sandwiched between separators, current collector plates, heater plates, insulator plates, and end plates, which had outer dimensions of 10 cm×10 cm, and the entire unit was secured with clamping rods. The clamping pressure was 20 kgf/cm² per separator area. Each of the anode-side and cathode-side separators was made of a 4-mm-thick glassy carbon plate having a serpentine flow channel with a width of 1.5 mm and a depth of 1 mm on the anode-facing or cathode-facing side. The current collector plates were gold-plated stainless steel plates, and the end plates were stainless steel plates. In this way, a fuel cell A was produced.

### EXAMPLE 2

A fuel cell B was produced in the same manner as in Example 1 except that the weight ratio of conductive carbon black/PTFE in the porous composite layer 31 was changed to 5/3, and that the thickness of the porous composite layer 31 was changed to approximately 30 μm.

### EXAMPLE 3

A fuel cell C was produced in the same manner as in Example 1 except that the first conductive porous substrate 32 was subjected to a water-repellency treatment with a dispersion containing 13% by weight of PTFE so as to attach 20.5% by weight of PTFE thereto, and that the thickness of the porous composite layer 31 was changed to approximately 60 μm.

### EXAMPLE 4

A fuel cell D was produced in the same manner as in Example 1 except that carbon paper TGP-H030 available from Toray Industries Inc. was used as the second conductive porous substrate 33 and was subjected to a water-repellency treatment with a dispersion containing 7% by weight of PTFE so as to attach 11.5% by weight of PTFE thereto.

### EXAMPLE 5

A fuel cell E was produced in the same manner as in Example 1 except that the second conductive porous substrate 33 was subjected to a water-repellency treatment with a dispersion containing 7% by weight of PTFE so as to attach 11.5% by weight of PTFE thereto.

### EXAMPLE 6

A fuel cell F was produced in the same manner as in Example 1 except that the first conductive porous substrate 32 was subjected to a water-repellency treatment with a dispersion containing 3% by weight of PTFE so as to attach 5.5% by weight of PTFE thereto, that the weight ratio of conductive carbon black/PTFE in the porous composite layer 31 was changed to 5/3, and that the thickness of the porous composite layer 31 was changed to approximately 20 μm.

### EXAMPLE 7

A fuel cell G was produced in the same manner as in Example 1 except that the first conductive porous substrate 32 was subjected to a water-repellency treatment with a dispersion containing 13% by weight of PTFE so as to attach 20.5% by weight of PTFE thereto, and that the thickness of the porous composite layer 31 was changed to approximately 80 μm.

### EXAMPLE 8

A fuel cell H was produced in the same manner as in Example 1 except that carbon paper TGP-H030 available from Toray Industries Inc. was used as the second conductive porous substrate 33 without subjecting it to a water-repellency treatment.

### EXAMPLE 9

A fuel cell I was produced in the same manner as in Example 1 except that the second conductive porous substrate 33 was subjected to a water-repellency treatment with a dispersion containing 13% by weight of PTFE so as to attach 20.5% by weight of PTFE thereto.

### EXAMPLE 10

A fuel cell J was produced in the same manner as in Example 1 except that the porous composite layer paste was evenly applied onto the second conductive porous substrate 33 not onto the first conductive porous substrate 32 with a doctor blade.

### EXAMPLE 11

A fuel cell K was produced in the same manner as in Example 1 except that carbon paper TGP-H060 available from Toray Industries Inc. was used as the first conductive porous substrate 32 and was subjected to a water-repellency treatment with a dispersion containing 3% by weight of PTFE so as to attach 5.5% by weight of PTFE thereto, and that carbon paper TGP-H090 available from Toray Industries Inc. was used as the second conductive porous substrate 33 and was subjected to a water-repellency treatment with a dispersion containing 7% by weight of PTFE so as to attach 11.5% by weight of PTFE thereto.

### COMPARATIVE EXAMPLE 1

A fuel cell 1 was produced in the same manner as in Example 1 except that the anode diffusion layer was composed only of the first conductive porous substrate 32 (one-layer structure) and that carbon paper TGP-H120 available from Toray Industries Inc. was used.

### COMPARATIVE EXAMPLE 2

A fuel cell 2 was produced in the same manner as in Example 1 except that the anode diffusion layer was composed of the porous composite layer 31 and the first conductive porous substrate 32 (two-layer structure).

### COMPARATIVE EXAMPLE 3

A fuel cell 3 was produced in the same manner as in Example 1 except that the anode diffusion layer was composed of the porous composite layer 31 and the first conductive porous substrate 32 (two-layer structure), that carbon paper TGP-H120 available from Toray Industries Inc. was used as the first conductive porous substrate 32 and was subjected to a water-repellency treatment with a dispersion containing 13% by weight of PTFE so as to attach 20.5% by weight of PTFE thereto, and that the thickness of the porous composite layer 31 was changed to approximately 80 μm.

With respect to each of the anode diffusion layers used in Examples 1 to 11 and Comparative Examples 1 to 3, the flux of methanol permeating through the first conductive porous substrate 32 integrated with the porous composite layer 31 and the flux of methanol permeating through the second conductive porous substrate 33 were measured in the following manner. Table 1 shows the results.

In the fuel cells A to J, the methanol permeation flux through the second conductive porous substrate is greater than the methanol permeation flux through the first conductive porous substrate. In the fuel cell K, the methanol permeation flux through the first conductive porous substrate is greater than the methanol permeation flux through the second conductive porous substrate.

TABLE 1

| | | | | 6M methanol (0.14 cc/min) | |
|---|---|---|---|---|---|
| | Methanol permeation | | Whether or not the | Air (0.3 L/min) | |
| | flux through first | Methanol permeation | materials of porous | | Continuous power |
| | conductive porous | flux through second | composite layer got | | generating |
| | substrate and porous | conductive porous | into second | Current-voltage | characteristics [V] |
| | composite layer | substrate | conductive porous | characteristics | (Voltage retention rate |
| | mol/(cm² · min) | mol/(cm² · min) | substrate | [V] | [%]) |
| Cell A | 0.83 × 10⁻⁴ | 5.22 × 10⁻⁴ | No | 0.421 | 0.413 (98) |
| Cell B | 1.48 × 10⁻⁴ | 5.22 × 10⁻⁴ | No | 0.391 | 0.368 (94) |
| Cell C | 0.62 × 10⁻⁴ | 5.22 × 10⁻⁴ | No | 0.399 | 0.383 (96) |
| Cell D | 0.83 × 10⁻⁴ | 7.86 × 10⁻⁴ | No | 0.415 | 0.403 (97) |
| Cell E | 0.83 × 10⁻⁴ | 4.65 × 10⁻⁴ | No | 0.408 | 0.396 (97) |
| Cell F | 1.63 × 10⁻⁴ | 5.22 × 10⁻⁴ | No | 0.368 | 0.302 (82) |
| Cell G | 0.57 × 10⁻⁴ | 5.22 × 10⁻⁴ | No | 0.372 | 0.320 (86) |
| Cell H | 0.83 × 10⁻⁴ | 9.18 × 10⁻⁴ | No | 0.381 | 0.339 (89) |
| Cell I | 0.83 × 10⁻⁴ | 4.38 × 10⁻⁴ | No | 0.389 | 0.354 (91) |
| Cell J | 0.83 × 10⁻⁴ | 5.22 × 10⁻⁴ | Yes | 0.379 | 0.326 (86) |
| Cell K | 1.68 × 10⁻⁴ | 3.23 × 10⁻⁴ | No | 0.355 | 0.284 (80) |
| Cell 1 | 2.45 × 10⁻⁴ | — | — | 0.146 | Power not continuously |
| | | | | | generated |
| Cell 2 | 0.83 × 10⁻⁴ | — | — | 0.332 | 0.239 (72) |
| Cell 3 | 0.51 × 10⁻⁴ | — | — | 0.272 | 0.131 (48) |

### (1) Methanol Permeation Flux

An H-shaped cell 60 made of glass, as illustrated in FIG. 5, was used. The cell 60 includes a glass container 61, a glass container 62, and a connecting part 63 that connects the containers 61 and 62. The connecting part 63 has a cross sectional area of 3.14 cm² and is equipped with rubber rings 67 and 68 for holding a sample 66 therebetween. The sample 66 used was the second conductive porous substrate 33 or the first conductive porous substrate 32 integrated with the porous composite layer 31. This cell 60 was placed in a 60° C. constant temperature oven. A 6M methanol aqueous solution of 50 cc was introduced into the glass container 61, while 200 cc of ion-exchange water was introduced into the glass container 62. These solutions were stirred at a constant speed with stirrers 64 and 65. Thereafter, approximately 1 cc of the aqueous solution in the glass container 62 was sampled every certain period of time, and the methanol concentration was determined by gas chromatography. Based on the increased amount of methanol per unit time, methanol permeation flux was calculated.

Next, fuel cell systems as illustrated in FIG. 4 were fabricated by using the fuel cells A to K of Examples 1 to 11 and fuel cells 1 to 3 of Comparative Examples 1 to 3. These fuel cell systems were operated to evaluate the current-voltage characteristics and continuous power generating characteristics of their fuel cells. The evaluation method is described below and the evaluation results are shown in Table 1.

### (2) Current-Voltage Characteristics

A 6M methanol aqueous solution was supplied to the anode side at a flow rate of 0.14 cc/min, while air was supplied to the cathode side at a flow rate of 0.3 L/min. While the cell temperature was kept at 60° C., power was generated at a current density of 150 mA/cm². After the power generation for 15 minutes, the effective voltage was measured. In this evaluation condition, the amount of fuel supply was set to 1.5 times the amount of fuel consumed by power generation, and the amount of air supply was set to 3.1 times the amount of air consumed by power generation.

### (3) Continuous Power Generating Characteristics

The effective voltage after the 15-minute power generation of a fuel cell under the above-mentioned conditions was defined as initial voltage. Under the same conditions, power was continuously generated for 100 hours and the effective voltage was measured. The ratio of this voltage to the initial voltage (voltage retention rate) was calculated.

Table 1 clearly shows that the fuel cells A to K have excellent power generating characteristics under the operating conditions utilizing high concentration methanol. This is due to the three-layer structure of the anode diffusion layer composed of the conductive porous substrate imparted with water-repellency, the porous composite layer, and the conductive porous substrate. The three-layer structure made it possible to control the blockability of fuel in the thickness direction of the diffusion layer and enhance the diffusibility of fuel in the plane direction thereof. The fuel cells A to E, in particular, exhibited dramatic improvements in power generating characteristics. The reason is probably as follows. First, the flux of methanol permeating through the first conductive porous substrate integrated with the porous composite layer and the second conductive porous substrate, which form the anode diffusion layer, was controlled in an appropriate range. Second, the porous composite layer and the second conductive porous substrate were laminated without allowing the materials of the porous composite layer to get into the second conductive porous substrate, so that a suitable amount of methanol could be evenly diffused in the plane direction of the diffusion layer.

On the other hand, in the case of the fuel cell 1 of Comparative Example, the anode diffusion layer has a one-layer structure composed only of the conductive porous substrate imparted with water-repellency. Thus, the blockability of methanol in the thickness direction of the diffusion layer became insufficient, so that the methanol crossover upstream of the fuel flow channel increased significantly, thereby resulting in a significant degradation of power generating characteristics.

In the case of the fuel cell 2 of Comparative Example, the anode diffusion layer has a two-layer structure composed of the conductive porous substrate imparted with water-repellency and the porous composite layer. Hence, it was difficult to evenly diffuse a suitable amount of methanol in the plane direction of the diffusion layer, and probably for this reason, power generating characteristics degraded.

In the case of the fuel cell 3, the anode diffusion layer has a thick two-layer structure composed of the conductive porous substrate imparted with water-repellency and the porous composite layer. Thus, the amount of fuel supplied to the catalyst layer became insufficient, so that concentration polarization increased, thereby resulting in degradation of power generating characteristics.

In the embodiments of the present invention, the diffusion layer is a laminate of three layers, but is not limited thereto. Also, the porous composite layer may be composed of two layers having different weight ratios of conductive carbon black/PTFE.

The fuel cell according to the present invention can directly utilize methanol, dimethyl ether, or the like as fuel without reforming it into hydrogen, thus being useful as the power source for portable small-sized electronic devices, such as cellular phones, personal digital assistants (PDA), notebook PCs, and video cameras. Also, the fuel cell according to the present invention is applicable to electric scooters, power sources for automobiles, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A direct oxidation fuel cell comprising at least one unit cell, said at least one unit cell comprising an anode, a cathode, a hydrogen-ion conductive polymer electrolyte membrane interposed between said anode and said cathode, an anode-side separator with a flow channel for supplying and discharging a fuel to and from said anode, and a cathode-side separator with a gas flow channel for supplying and discharging an oxidant gas to and from said cathode,
wherein said anode comprises: a catalyst layer in contact with said polymer electrolyte membrane; and a diffusion layer, and
said diffusion layer comprises: a porous composite layer comprising a water-repellent binding material and an electron-conductive material; a first conductive porous substrate provided on an anode-side separator side of said porous composite layer; and a second conductive porous substrate provided on a catalyst layer side of said porous composite layer.

2. The direct oxidation fuel cell in accordance with claim 1, wherein a flux of the fuel permeating through said first conductive porous substrate and said porous composite layer is less than a flux of the fuel permeating through said second conductive porous substrate.

3. The direct oxidation fuel cell in accordance with claim 1, wherein said porous composite layer has a substantially flat surface to which said second conductive porous substrate is joined, so that the water-repellent binding material and the electron-conductive material of said porous composite layer are kept from getting into said second conductive porous substrate.

4. The direct oxidation fuel cell in accordance with claim 1, wherein said water-repellent binding material is composed mainly of fluorocarbon resin.

5. The direct oxidation fuel cell in accordance with claim 1, wherein said electron-conductive material is composed mainly of conductive carbon black.

6. The direct oxidation fuel cell in accordance with claim 1, wherein said first conductive porous substrate and said second conductive porous substrate contain a water-repellent binding material.

7. The direct oxidation fuel cell in accordance with claim 6, wherein said water-repellent binding material is composed mainly of fluorocarbon resin.

8. A method for operating a direct oxidation fuel cell system comprising: the fuel cell of claim 1; a fuel tank connected to an inlet of the anode of said fuel cell by a fuel supply path; a fuel discharge path connected to an outlet of the anode of said fuel cell; an oxidant supply source connected to an inlet of the cathode of said fuel cell by an oxidant supply path; and an oxidant discharge path connected to an outlet of the cathode of said fuel cell,
said method comprising operating said fuel cell system such that the amount of the fuel supplied to the anode of said fuel cell is 1.1 to 2.2 times the amount of the fuel consumed by power generation of said fuel cell.

9. The method for operating a direct oxidation fuel cell system in accordance with claim 8,
wherein said fuel is methanol or a methanol aqueous solution, and
said method comprises operating said fuel cell system at a fuel concentration and a cell temperature such that a flux of the fuel permeating through said first conductive porous substrate and said porous composite layer is 0.6×10⁻⁴ to 1.5×10⁻⁴ mol/(cm²·min).

10. The method for operating a direct oxidation fuel cell system in accordance with claim 8,
wherein said fuel is methanol or a methanol aqueous solution, and
said method comprises operating said fuel cell system at a fuel concentration and a cell temperature such that a flux of the fuel permeating through said second conductive porous substrate is 4.5×10⁻⁴ to 8.0×10⁻⁴ mol/(cm²·min).
